(19) United States
(12) Patent Application Publication
(10) Pub. No.: US 2006/0293045 A1
(43) Pub. Date: Dec. 28, 2006

(54) Evolutionary synthesis of a modem for band-limited non-linear channels

(76) Inventor: Christoph Karl LaDue, Brighton Beach (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/441,672

(22) Filed: May 25, 2006

Related U.S. Application Data
(60) Provisional application No. 60/685,133, filed on May 27, 2005.

(51) Int. Cl. H04Q 7/20

(52) U.S. Cl. 455/423; 455/425

(57) ABSTRACT

A method of selecting optimized encoding symbols and decoding parameters for a communications neural network using a genetic algorithm. A population of individuals representing the symbols and parameters of the communications neural network is evolved through successive generations to create increasingly effective neural network characteristics. In one embodiment, the final optimized neural network is implemented on a band-limited non-linear channel of a communication network.

### PRIORITY

This application expressly claims priority to U.S. Provisional Application No. 60/685,133 entitled Evolutionary Synthesis of a Modem for Band-Limited Non-Linear Channels, filed on May 27, 2005 by Christoph Karl LaDue, and commonly assigned to the Assignee of this application.

### BACKGROUND OF THE INVENTION

1. Field of the Invention

The invention relates to utilising octave-harmonic evolutionary synthesis symbolic language protocols that enable a completely novel self-adaptive communication methods for the purpose of creating optimised performance and security for any digital wireless and wireline network topology.

2. Description of Related Art

The related art includes telecommunications technology that offers many enhancements to conventional wireless service offerings to network operators and wireless customers such as Orthogonal Frequency Divisional Modulation (OFDM), Fractal Modulation and the like. Telecommunications has become an integral part of nearly every person's life on the planet today. Wireless communications is fast becoming the dominant means of deploying infrastructure based services to vast areas of the globe. In the near future wireless communication networks will provide the basis for all core communications infrastructure in the emerging economies. There exists a plethora of different communications network architectures and methodologies, such as GSM TDMA, CDMA, CDMA2001RX, UMTS, SDCDMA, OFDM, etc. Only one wireless network has the topological penetration that has the potential of serving a vast majority of the world's population and that is GSM. The Global System for Mobile (GSM) network today serves more than a billion users in over 200 nations around the globe. While the majority of the development efforts are concentrated on so-called new technologies, these new technologies are focused on shared network packet switching methods that require massive infrastructure installations that may not produce the desired utilitarian ends for mass human populations.

The invention introduces a novel approach to communicating data over a digital mobile cellular voice channel such as GSM, CDMA and mobile trunked radio (MTR) communication networks, Third Generation mobile cellular communication topologies and the like. The invention is based upon the concept of using symbols—a set of predefined signals with finite bandwidths. Data is encoded into the symbols for transmission through a voice CODEC, and decoded at a receiver by a maximum likelihood method. The symbols are synthesized by a genetic algorithm with the aim of maximizing their separability. This evolutionary synthesis represents a new paradigm in communication system design and moves forward the adaptive multi-rate symbolic modulation method and language of Octave Pulse Data (OPD) systemic protocols, processes and procedures of sampled harmonic structures that can be applied to any wireless, wireline and optical communications channel and network topology. A discussion of ODP protocols is available in U.S. patent application Ser. No. 09/573,466, filed May 17, 2000.

### SUMMARY OF THE INVENTION

The invention introduces a new approach to communicate data over a mobile cellular, GSM, TDMA, CDMA, and digital Mobile Trunked Radio (MTR) voice channel. The protocols, processes and procedures are based on the concept of creating and applying symbols: a set of predefined signals with finite bandwidths. Data is encoded into the symbols for transmission through a voice CODEC, and decoded at a receiver by a maximum likelihood estimation (MLE) method. The symbols are synthesized by a cooperative genetic algorithm approach with the aim of maintaining separability after passing them through the voice CODEC, and reducing the size of dictionary redundancy. The disclosure presents the full algorithmic structure of the system performing data communications over the GSM voice channel as one of many potential communication channel examples to which different embodiments of the invention can be applied. The protocols, processes and procedures utilise evolutionary synthesis which defines a new paradigm in communication system design.

### BRIEF DESCRIPTION OF THE DRAWINGS

FIG. 1 depicts the basic Genetic Algorithmic (GA) procedure, according to an embodiment of the invention.

FIG. 2 depicts a logical block diagram of a digital band-limited voice channel communication topology, according to an embodiment of the invention.

FIG. 3 depicts a logical circular diagram of the multidimensional search space which accommodates symbols, according to an embodiment of the invention.

FIG. 4 depicts a logical diagram of the real spectrum, and imaginary spectrum that is combined by the DFT transform, according to an embodiment of the invention.

### DETAILED DESCRIPTION OF EMBODIMENTS OF THE INVENTION

The new Third and Fourth Generation mobile cellular communication methods do not deliver the vast majority of what the commercial user needs for a wide range of application specific services: ease of use, high security of individual user traffic, priority routing, rapid message delivery of user traffic, low cost, customised virtual channelisation, and efficiency and service accessibility over large transaction areas also known as application point of use (APU). In many cases there are ways to extend the life of various wireless communication networks. One of the most sought after improvements is to add data transmission ability to current “voice-only” networks such as GSM and selected mobile trunked radio (MTR) communication topologies. The GSM network and MTR networks do have dedicated data channels, however these channels have a number of problems, including long connection time, unacceptable asymmetrical delay, interoperability issues and high cost for usage.

An embodiment of the invention can be applied to secure financial communication networks. These networks support automatic teller machine (ATM) communications, point-of-sales (POS) terminals, teller terminals, bank switching networks and the like. An embodiment of the invention is also designed to be applied Voice Over Internet Protocol (VOIP) networks for the purposes of secure voice and secure data. Yet another embodiment of the invention can be applied to data and VOIP channels that are used over IEEE802.11, IEEE802.16, IEEE802.21 distributed networks. Still another embodiment of the invention provides the means and method of tunneling secure data samples within the topological structures of variable voice samples and the like.

The invention significantly solves the problem of propagating variable length, variable width and variable depth symbolic-samples over communication channels with memory. The invention applies evolutionary synthesis methods that represent a new paradigm in communication system design. An embodiment of the invention provides adaptive multi-rate symbolic modulation, that is the core method that embodies the nth dimensional language of Octave Pulse Data (OPD). OPD introduces variable systemic protocols, processes and procedures of sampled harmonic structures that can be applied to any wireless, wireline and optical communication channels and related network topologies. The inherent nth dimensional symbolic flexibility of each Octave Pulse Data/Adaptive Multi-Rate (OPD-AMR) symbolic sample also can be applied to communication system security. Accordingly, the invention applies mathematical genetic algorithmic procedures for the purpose of (1) generating near infinite symbolic-sample state variability, (2) generating near infinite symbolic dictionary samples and (3) generating near infinite Octave Pulse Data/Adaptive Multi-Rate (OPD-AMR) modulation methods. These novel methods can be applied to a vast plethora of existing and yet to be developed communication channel structures and communication system topologies.

One communications channel that one embodiment of the invention has been applied to is the GSM mobile cellular digital voice channel, however this does not limit how the invention is applied with respect to any target communications channel topology. The GSM channel is a non-linear channel with memory. Transmitting predictable lossless data information through these channels has been deemed impossible by the engineering community-at-large. Up until now there have been significant problematic factors that significantly hinder the practical use of any of these data channels for fast transmission of lossless data messaging. A solution to these problems would be to use the compressed speech channel itself in order to transport bi-directional data, text, audio files and video files. The problem lies in the fact that the GSM voice channel is effectively a band-limited non-linear channel with memory: it is designed for voice-like signals and not for data. In order to allow greater channel capacity the GSM vocoder extracts the parameters characterising a speech model that mimics how humans generate speech and listen to such speech. Only these parameters are sent over the air. At the receiver these parameters are used to generate a replica or sample of the original speech information.

Transmitting the parameters alone leads to a compression rate of approximately 8.5 times. Although to the human ear, the regenerated speech sounds very similar to the original, its waveform can in fact be quite different. Moreover, it is problematic to achieve reasonable error rates while communicating data over the compressed voice channel using conventional modulation techniques, because data communication relies on sample-by-sample matching, not on perceptual similarity. An obvious way to compensate for the channel impact is to apply channel equalisation but this would require direct or indirect identification of the channel inverse. The non-linear nature and differential encoding of the speech parameters makes this channel virtually unidentifiable in terms of structures usually used as equalisers e.g., finite impulse response (FIR) and infinite impulse response (IIR), decision feed back, random corrective speech frame replacement, and the like.

Therefore, data communication over a non-linear channel with memory, such as a GSM voice channel, a CDMA voice channel, and other relate channel structures has a unique set of problems that stipulate the design of this conceptually and applicable new approach specifically targeted to the task. The systemic paradigm disclosed here fuses evolutionary optimisation with the science of neural networks in order to adapt a set of band-limited signals called symbols in order to maintain the distinct separability of the symbols at the receiver side. This method allows for the development of entire communication network topologies that function quite different and behave like a biological organism that “self adapts” and “self corrects” in accordance with an embodiment of the invention. A central innovation guiding one embodiment of invention is the evolutionary adaptation to the compressed voice channel, which is impossible to invert due to its non-linear lossy nature. This embodiment of the invention represents a new framework for the communication system design: the signal set is adapted to the voice CODEC by natural selection. The general concept of adaptation to the channel could potentially be applied to any receiver structure and signal type, including massive topologies of voice over internet protocol (VOIP) protocols and networks.

Artificial neural networks (NN) have been shown to be an effective tool for non-linear system identification and pattern recognition when the system transfer function is unknown, and only input-output vector relations of symbols are available for observation. The NN is used as a decision device to identify which of the possible symbols over a finite set that can be sent through the system such as a GSM voice channel with unacceptable error rates. Of the many types of neural networks, the Radial Basis Function (RBF) has been selected. Advantages of the RBF network over other NN architectures include a deterministic training process and a relatively simple microcosmic network topology.

RBF networks also perform supervised learning, for example, regression, classification, and time series prediction. An RBF network is simply a linear function approximator using RBFs for its core features. Learning is defined by non-proprietary equations. The primary advantage of RBFs over binary features is that they produce approximate functions that vary smoothly, are differentiable and offer inverse predictability. In addition, some learning methods for RBF networks change the centres and widths of the features, and perform well in terms of control over model complexity, and regression trees in order to generate clear RBF centres and radii. This tangentially relates to the changes in symbol frequency, amplitude and phase in a two dimensional linear and a non linear channel. This aspect immediately addresses selected in-channel sample states that maintain symbol separability. This core feature also directly relates to symbolic state generation within selected bandwidth features for target channels in terms of frequency, amplitude, and phase relationships of each symbol, and the band-limited qualitative metrics of the channel itself.

In order to perform pattern recognition, the RBF network must be trained and its parameters must be tuned to match both the signal and the channel. Although the RBF network can be trained by various methods, the parameter adaptation is generally signal dependent, i.e. an input signal, and the associated output, are required to train the neural network in order to create matched filter inverse topology arrays. This presents an ambiguous situation when it is necessary to simultaneously adapt the signal to maintain separability within the channel constraints. Both the RBF network and the signal itself must be designed together in order to compliment one another. Therefore, typically, there is a non-linear optimsation problem with high dimensionality. This type of problem is not easily solved by means of any gradient-based optimisation methods well known in the art. Thusly, Genetic Algorithm (GA) as a method of stochastic optimsation, was chosen both to adapt the NN parameters, and generate the symbols synchronously. Hence, in accordance with an embodiment of the invention, a modem or network element comprises a set of band-limited signals, “symbols”, used to transmit data, and the RBF network based decision device both of which are evolved by the GA.

The theoretical and applied background on which an embodiment of the invention is based includes the infinite variability of musical structures such as octaves/quavers, notes, and simultaneous propagation of multi-rate beat patterns that are produced by acoustic and digital musical instruments. The invention applies a Genetic Algorithm (GA) which is a global optimisation technique based on the theory of Cybernetics, Metasystem Transition (MT), Darwinian evolution, and computer science. Genetic Algorithms (GA) are known to have been successfully applied to complex numerical problems that can be related to nth dimensional musical note structures, which cannot be solved analytically. These include multi-nodal function optimisation and parameter adaptation for complex structures such as neural networks of different architectures. From a Cybernetic point of view the salient Metasystem transition (MT) is applied between the transmitter and receiver, in terms of symbolic-sample adaptation towards instant communication channel condition. This method creates a communication network node that self adapts and optimises within preset limits defined by the metrics of existing legacy network channel topologies. However, various embodiments of the invention are designed to be applied to the creation of revolutionary channel and network element structures that have yet to be implemented.

The basis for the Genetics Algorithm is the Schemata theorem which in its general form can be stated as follows: the population members with higher fitness have a higher probability of producing fitter offspring. This constitutes the general GA framework: a set of special “genetic” operators evolves a population of individuals leading to adaptation by natural selection. So, optimisation by GA can be expressed in the following form. Firstly, a population of entities is selected at random from the entire solution space. Hence, the population comprises a set of possible solutions to the problem at hand. The “fitness” of each entity is assessed, where the fitness represents the cost function being solved. The population is then sorted based upon the fitness to ensure the fitter entities are more likely to be selected for mating. The set of genetic operators such as crossover—combining, and mutation—random alteration is applied to the selected entities to produce offspring, which are added to the population. The fitness is reassessed and the least fit entities, i.e. those that cannot maintain symbol separability are removed from the pool. This process of assessment, selection, offspring generation, and removal is repeated until the desired performance has been achieved.

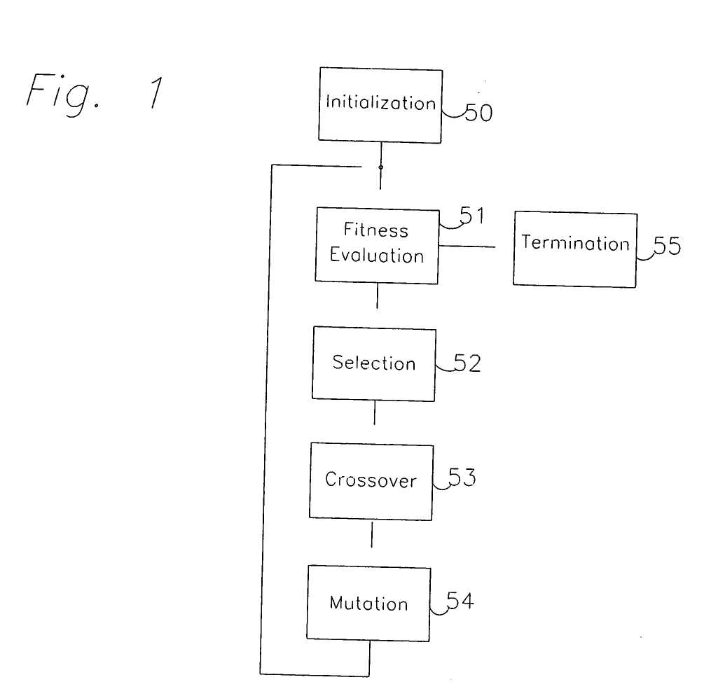

Referring to FIG. 1, The genetic algorithmic steps are Initialisation 50: set up initial population, assign probabilities of crossover—combining, and mutation—random alteration. Other variables necessary for GA include Fitness Evaluation. Thus, at 51, calculate fitness of each individual in the population. The fitness represents a function being optimized. The next step, Selection 52: is the process in which parents are ranked with the intent of improving the fitness of the next generation. Fitter individuals are selected to reproduce offspring for the next generation. Selected probabilities are assigned based on an individual's fitness. The individuals in the populations are sorted according to their fitness. At step Crossover 53: new individuals are generated by exchanging features of the selected parents. Next, at Mutation 54: the mutation is to keep diversity of a population. It is performed by adding a random disturbance to one or several components of an individual. Finally, at Termination 55: the termination occurs when the target fitness is reached or a certain number of generations has passed and the optimised symbol has been generated that best fits the instant condition of a selected band limited channel with memory.

The survival of the fittest approach mimics the natural selection that occurs in natural evolution. The RBF network is a multilayer network represented by three layers: input, hidden, and output layers. The RBF network operates in the following way: every node of the input layer feeds input samples to the non-linear processing units of the hidden layer, which are in turn linearly combined in the output layer. This can be considered as a mapping value, where the dimensionality of the input vector and a predetermined mathematical value produce the self-similarity of the dimensionality of the output vector with improved performance related symbolic properties.

The GSM Voice Channel, like any digital mobile cellular voice channel, is a non-linear channel with memory. The channel is defined by the GSM Enhanced Full Rate Voice CODEC and how it generates voice samples. The GSM voice CODEC performs mapping between input speech bursts to encoded bit blocks, and from encoded bit blocks to reconstructed speech samples, yielding a compression ratio of more than eight times and a bit rate for the encoded bit stream of 12.2 kbit/s. The coding scheme used for compression/decompression is the Algebraic Code Excited Linear Prediction Coder (ACELP). In its general form, the algorithm compares the input speech signal with a speech model that replicates the effects of the vocal tract, and the natural hearing apparatus during full duplex communications on the receiver side.

The algorithm also computes the errors between the original speech and the model. It transmits both model parameters and a compressed representation of the errors. On the receiver side, the reverse process is performed to reconstruct the original speech signal. This process involves multiple quantisations, differential encoding and a feed-back loop, which makes this CODEC a highly non-linear system with memory. As a consequence of the non-linearity the channel impact is signal dependent. Although, to a human listener, the reconstructed speech may sound very similar to the original, the waveform is often very different when comparing sample by sample. This makes the GSM voice channel virtually unusable for data transmission without some kind of channel compensation. On the other hand, the non-linear nature of the CODEC makes it problematic to apply conventional equalisation techniques, which rely on direct or indirect channel estimation.

One embodiment of the invention introduces a novel approach to communicate symbolic-data through the GSM digital voice channel, a CDMA digital voice channel, a VOIP voice channel, a MTR voice channel, and the like. This approach does not require explicit channel equalisation. It rather relies on having a set of symbols that maintain their recognisable separability when transmitted through the channel, and a stochastic decision device which is able to recognise the symbol even after it was significantly changed by the encoding-decoding process. Both of these components are adapted to the channel by the same evolution process. The neuronet (NN) based decision device incorporates inherent channel compensation because the parameters of its hidden layer have been optimised for both the signal and the voice channel. An advantage of this system is that the effects of the channel are alleviated on a symbol-by-symbol basis, that is, a different compensation model is applied to each symbol. The compensation model is algorithmically linked to the instant condition of the communication channel that each symbol is applied to.

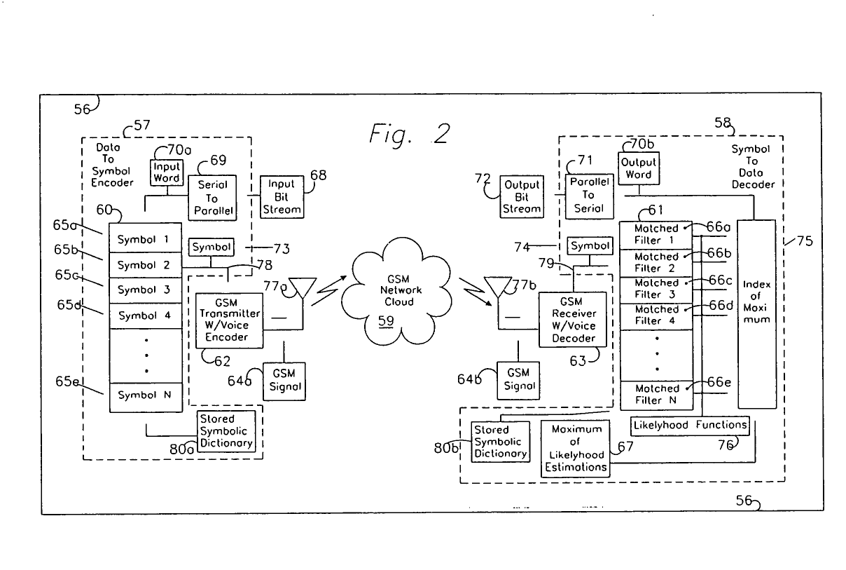

The general structure of the modified GSM modem 56 is illustrated in FIG. 2. The elements in FIG. 2 detail both the transmitter 57 and the receiver 58 side of the modem respectively. The drawing elements can also illustrate how two different modems can communicate symbolic data between each other across a GSM Public Land Mobile Network (PLMN) network 59. In still another interpretation, the illustration can also be interpreted as one modem showing the transmitter and receiver side of the modem as separate entities working in conjunction. The in-channel or virtual modulation method applied by one embodiment of the invention consists of dividing the incoming data bit stream 68 into serial-to-parallel decimal words 69 of an appropriate magnitude, and then simply using these numbers to address the symbolic dictionary 60 containing the selected vector symbols such as Symbol 1 65a, Symbol 2 65b, Symbol 3 65c, Symbol 4 65d, Symbol N 65e, that are defined by designated mathematical procedures. While mathematical equations are not in and of themselves unique, it is the unique application of the results of mathematical quantitative and qualitative equations which define novel algorithmic-protocols. These disclosed functions using a different perspective of applicable Genetic Algorithms (GA) to create novel protocols, processes and procedures provided by one embodiment of the invention.

These procedures are dependent upon and adapted in accord with the physical layer, frequency domain, bandwidth and host modulation limits of the channel so applied to such as a GSM voice channel. These parameters tend to define the limits or size of the one or a plurality of dictionaries that can be utilised at any given point in time. However there is no theoretical or actual defined limit of the stored symbolic dictionary. The application of cooperative Genetic Algorithms (GA) in accordance with an embodiment of the invention enables the generation of n-dimensional symbolic variations, therefore, the only limit that can be defined is based upon the size of storage system utilised, and the channel bandwidth each symbol is applied to and propagated. From the transmitter side these defined frequency, amplitude and phase related symbolic vectors are then concatenated and framed into packets in order to form the transmitted GSM signal 64a. After passing through the voice channel via the transmitting antenna 77a, and the GSM PLMN cloud 59 the signal is detected by the receiver antenna 77b, passed to the GSM receiver with voice decoder 63 using a known synchronisation preamble. The next step is that the decoding process is performed by the RBF neural network algorithmically and physically contained within the decoder 61.

In this step, the network identifies the symbols 74 and outputs the associated data vector using the mapping method that is defined by selected equations stochastically measured by each matched filter 1 66a, 66b, 66c, 66d and 66e that corresponds by the maximum of likelihood estimations 67. These equations define the likelihood functions 76 of the index of maximum parameters 75 that it identifies. This identification process involves how each likelihood function recognises the corresponding symbol that is maintained in the stored symbolic dictionary 80b. Each matched filter in the receiver algorithmically approximates each of the symbols that are stored in the transmitters stored symbolic dictionary 80b. This is a straightforward and uncomplicated communication system, with the sophistication derived from the generation of the symbols in the dictionary, and the decoding by the neural network contained algorithmically and physically in the receiver.

The Reed-Solomon source coding is the intuitive choice for forward error correction (FEC) because it operates in one-bit word increments rather than bit streams. This complies with the fact that each symbol encodes bits of data, so errors occur in bit blocks instead of being evenly linearly distributed. So, the ability of Reed-Solomon codes that can correct errors in bit words makes it an efficient FEC method for this application in conjunction with the cooperative genetic algorithm (GA) adaptive multi-rate modulation method.

In accordance with an embodiment of the invention, the modem is designed in one or more possible ways to enable data transfer through the GSM voice CODEC without causing disruption to the conventional digital voice channel operation as prescribed by international standards. The central innovative approach is to design a signal, more precisely, a set of waveforms, i.e. symbols which fit into the voice band range of 300-3400 Hz and which can be successfully decoded after passing them through the vocoder. Expressed in yet another way, the data is mapped onto these symbols on the transmitter side 57 and extracted from them on the receiver side 58. In one embodiment of the invention, the unique application of data-to-symbol Reed-Solomon encoding scheme and symbol-to-data Reed-Solomon decoding scheme is described as follows. This novel method represents a data pre-coding technique which is defined by the in-channel parameters of the conventional GSM voice channel system which is band-limited with memory. The data-to-symbol Reed-Solomon encoder 60 is a table look-up, which maps from the input bit stream 68 that is converted from serial-to-parallel 69 decimal data, that further creates a data input words 70a onto symbols 65a, 65b, 65c 65d and 65e respectively.

The fittest symbol 73 is sent through the GSM transmitter that physically and algorithmically contains a voice encoder 62. The GSM transmitter 62 propagates a conventional GSM signal 64a that functions in accord within GSM traffic and user channel international standards. The signal contains the fittest symbol 73 that is propagated to the interconnected antenna 77a. The antenna oscillates within the defined frequency domain of a selected digital traffic channel that is part of the currently GSM public land mobile network (PLMN) cloud 59. The modem receiver 58 contains the symbol-to-data Reed-Solomon decoder 61 which receives and estimates sent data words using the maximum likelihood estimation (MLE) 67 method. The data-to-symbol encoding process consists of the following steps: Divide the incoming data bit stream into decimal words expressed with the following equation abbreviated here as I=1, 2. . . , N sym, where N sym=2 N bit. There is no one equation or set of equations that can solely express the quantitative and qualitative algorithmic procedures used in an embodiment of the invention. Therefore the invention is not limited to the mathematical equations disclosed here. Using these words address the dictionary D, which contains the symbols and the table that comprises the symbol ranges 60. These symbols are scaled to 13-bit integers, which are concatenated, and framed into packets.

The packets are then fed into the GSM unit as though they are formed into a differentiated harmonic signal. This unique harmonic signal is not comprised of tones, nor does it emulate human speech, but is propagated in patterns that are inherently asymmetrical. This novel asymmetrical pattern is designed to optimise the efficiency of the signal. In addition to being robust to the voice CODEC, the designed signal must be sufficiently voice-like in order to not raise any alarms in the GSM system. The GSM voice activity detection (VAD) is a technique designed to avoid transmission when there is no speech. The VAD constantly monitors the signal activity, to determine if speech is present or simply noise. If it concludes that there is no speech, it cancels transmission. This can cause problems for data transmission through the GSM channel, because the asymmetrical signal under this embodiment of the invention possesses white noise-like features. To ensure that the VAD indicates that there is voice present, it is sufficient to dynamically vary the spectral envelope of the signal, over a time scale of that approximately equals 80 ms or four 20 millisecond (ms) voice channel bursts. 80 ms is the time interval the VAD engine uses to gather statistics about the speech signal. To implement this, the transmitter can dynamically switch once every 80 ms or less between two symbol dictionaries or more that are designed to have different spectral shapes. Of course, this means that the same switching procedure is performed synchronously on the receiver side. Dictionaries with different spectral shapes can be generated by varying the active Fourier bins which are derived and generated by selected Fourier Transforms.

The asymmetrical octave pulse data (OPD) symbolic data signal in accordance with one embodiment of the invention is produced from the generation of different octaves of differentiated harmonics, as well as rapid changes in harmonic beat-pulse patterns that possess unique harmonic shifts of frequency, and amplitude and phase interrelationships. These unique qualities create symbols that equate to alpha numeric characters and the like. These novel interrelationships comprise the symbolic words that are generated by the engine/module. In the GSM unit they are passed through the voice encoder, modulated according to the GSM standard and sent over the air through the currently serving PLMN cloud 59. On the receiver 58 side the incoming signal is detected by the antenna 77b, demodulated and passed on by the GSM receiver/voice decoder 63.

Then, the GSM unit output symbol 74 is fed into the symbol-to-data decoder 58, which de-frames symbol packets and determines the beginning of the first symbol. The decoder/matched filter 66a, 66b, 66c, 66d, and or 66e detects each received symbol and decides which symbol is most likely to have been transmitted. The index of the symbol in the dictionary represents the estimate of the transmitted decimal word which in turn is converted to the output word, 70b, that is further converted from parallel to serial data, 71, and then fed to the output data bit stream 72. The GSM standard currently supports four speech compression techniques: full-rate, enhanced full-rate, adaptive multi-rate, and half-rate. The voice CODECs, or vocoders, are designed to the compressed speech signal at the transmitter and accurately regenerate it at the receiver. The digitized speech signal of a resolution of 13 bits and sampling rate of 8 kHz forms the input to the GSM speech CODECs, in one embodiment of the invention. The encoder extracts the speech parameters which are then arranged into a bit-stream. The output rate of the speech encoder depends on its type.

The parametrised compressed speech signal is encoded and modulated according to the GSM specification and sent over the air. After demodulation, the bits are fed into the speech decoder to synthesize the original speech. The invention primarily utilises the GSM Enhanced Full Rate Voice CODEC (EFRV) because it enables the best performance parameters over a GSM voice channel for the purposes of symbolic data transmission. However, the approach should be general enough to be applied to any voice CODEC and the channel it creates. The EFRV is a lossy voice CODEC which performs mapping between input speech bursts to encoded bit blocks, and from encoded bit blocks to reconstructed speech samples, yielding compression ratio of 8.5 times and a bit rate for the encoded bit stream of 12.2 kb/s. The coding scheme used for compression/decompression is the Algebraic Code Excited Linear Prediction Coder (ACELP). The EFRV uses a 10th-order short-term. linear prediction and a long term linear prediction filters. These filters are excited with a combination of adaptive and algebraic codebooks. The variations of GSM CODEC Output Bit Compression provide, Compression Rate, kb/s times Algorithm Full Rate 13 8 RTE-LTP, Enhanced Full Rate 12.2 8.5 ACELP, Half Rate 5.6 18.4 VSELP, AMR 12.2 8 ACELP, 10.2 10. 2 ACELP, 7.95 13.1 ACELP, 7.4 14.1 ACELP. 6.7 15.5 ACELP, 5.9 17.6 ACELP 5.15 20.2 ACELP, and 4.75 21.9 ACELP excitation vectors.

Embodiments introduce symbol design that is derived from a mathematical search problem. The symbols are generated in the frequency domain, so that selected frequencies are not allowed to generate outside of the designated bandwidth and effective radiated power (ERP). This power level is continually normalized in order to fit the standardised channel applied to, and avoid circumvention of the designated operational standard. At the same time the symbols should be robust enough to still be identifiable after passing through the voice CODEC. This robustness is a relative measure which can be expressed in terms of error rate. So, band limits and unity of power form constraints on the search space, for robust symbols which represents a cost function. The search space for the optimization problem can be applied as all discrete symbols of length samples in time whose frequency spectrum is contained in the frequency interval. Minimum Hz and maximum Hz Frequencies should be within the voice band, 300-3400 Hz, but their actual values are dictated by specified host GSM carrier requirements which even exacts additional performance constraints. The search space is also constrained by symbol power: so that the total power of each symbol is normalized.

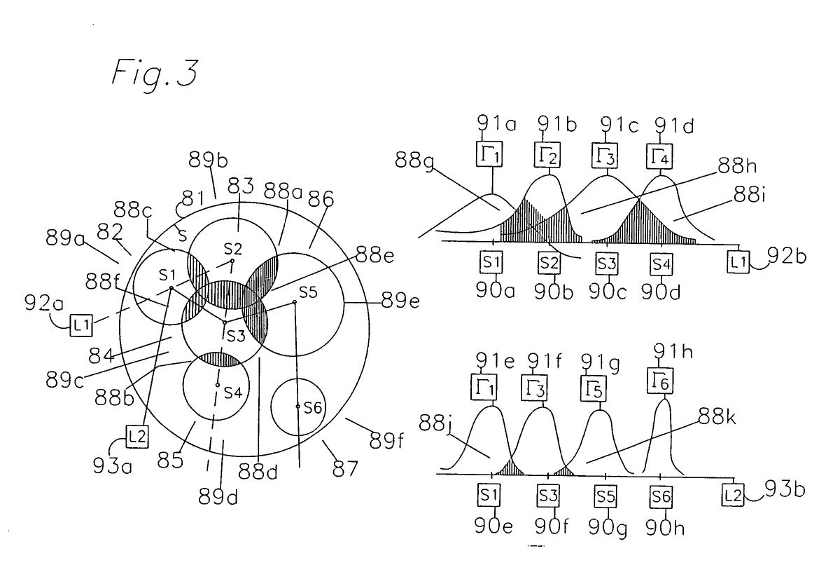

The most obvious cost function for the symbol is where there is counted the number of erroneous detections, compared to the number of times that the symbol was sent over the vocoder. In practice the cost function for all symbols is calculated by encoding a large amount of random data into the. symbols, then passing them through the voice CODEC, including both voice encoding and decoding processes. This is coupled with the application of maximum likelihood estimation (MLE) methods of symbol-to-data decoding procedures, while comparing the number of symbol misdetections, with the total number of times that each particular symbol passed through the voice CODEC. With the search space and cost function defined, there is a constrained minimization problem. Due to the discrete nature of the symbols, the search space is finite dimensional with dimensional structures that are proportional to the number of samples in a symbol. Hence the search space can potentially have a large number of dimensions. The cost function is defined by the output of the vocoder, and its tendency to be problematic in terms to be expressed analytically. However, there are some known features that the cost function possesses: non-linearity: it comes directly from the vocoder properties; cost functions for different symbols will not be independent. The fact relates to the inventions usage of the maximum likelihood estimation (MLE) decoding process, which implies that the more similar the symbols, the more difficult they are to distinguish in terms of symbol separability. In addition the vocoder has a memory, so the effect on the current symbol depends on the effect the vocoder has on the symbols passed through it. FIG. 3 illustrates the idealized illustration of symbol spaces, and the symbols passing through the vocoder. The drawing also illustrates the impact of the vocoder on the symbols.

Referring to FIG. 3, the plane S 81 represents a multidimensional search-space model which accommodates symbols S1 82, S2 83, S3 84, S4 85, S5 86, S6 87 as system style points in the channel designated and expressed graphically here as curvy lines L1 92a, L2 93a and straight lines L1 92b and L2 93b. Circles around each point encompass 99% of all possible vocoder outputs for each corresponding input symbol. The black shaded area depicted here 88a, 88b, 88c, 88d, 88e, 88f, 88g, 88h, 88i, 88j, and 88k corresponds to the error probability which can be defined visually and mathematically, i.e., predictably between each neighboring non-linear symbol. It is more convenient to visualize the symbols mutual impact along curvy lines and overlapping circles, each of which goes through the symbols of interest and where a defined quantum is the number of all possible symbol combinations. The circles 89a, 89b, 89c, 89d, 89e, 89f and bell shaped curves 90a, 90b, 90c, 90d, 90e, 90f, 90g and 90h denote probabilities of symbol occurrence after passing the signal through the voice CODEC. Errors occur where these probability distributions 91a, 91b, 91c, 91d, 91e, 91f, 91g, and 90h overlap. Therefore, the greater the overlap, the higher the cost function of either symbol size, the number of symbols per sample, and the speed of how symbols pass through the vocoder/channel. It should be noticed that an error-misdetection can potentially happen between any symbols from the symbol set. The invention is designed to find a symbol set from the search space such that probability distributions of the symbols-members of this set have minimal overlap, which equates to higher symbol resolution. This can be accomplished by performance-cost-function (PCF) minimization.

In the cooperative GA the entire population constitutes a single dictionary, with each member of the population comprising a single symbol. The result of the process is not a single optimal individual, but instead a population of individuals co-adapted to complement one another, with the whole population representing the symbol dictionary. To successfully develop a symbol dictionary in this way, each individual symbol must evolve to occupy its own niche, that is, it must not only perform well in its own right, in the case of the invention, transfer of symbols through the voice CODEC should occur with minimal distortion. But also be different enough from the other symbols that they can be distinguished reliably by the maximum likelihood estimation MLE symbol decoder. How to develop this cooperative behavior between members of a population is known as the niching problem in GA literature.

In one embodiment of the invention, the evolution of individuals that occupy their own niche is achieved by choosing a GA fitness function that implicitly favours those individuals that are different from the other symbols. The invention utilises the cooperative GA approach. The process of generating symbols is defined in four steps.

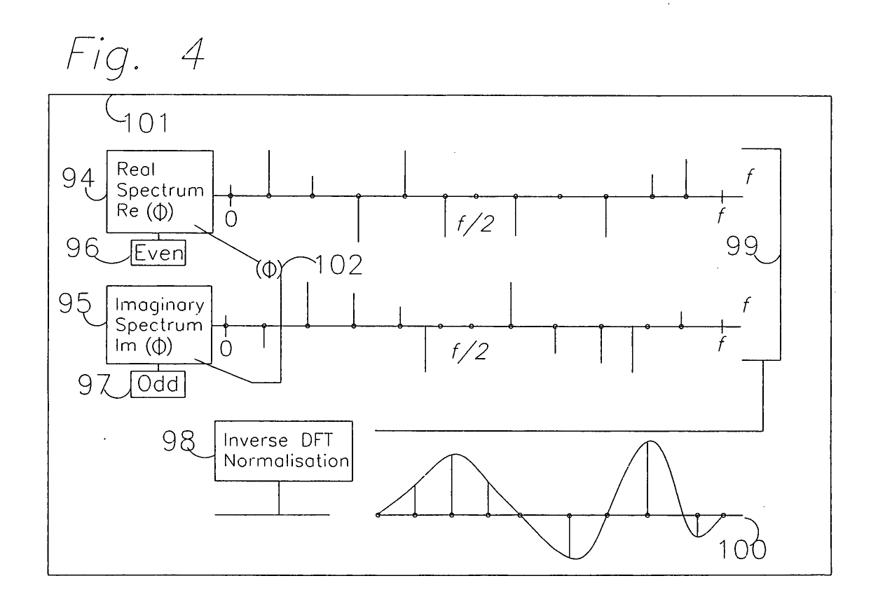

Step (A) Generate initial symbol set: According to the selected cooperative GA strategy in one embodiment of the invention, the entire population S of individuals si, I=1, 2 , . . . , Nsym constitutes a single symbol set. Each individual symbol si consists of Nsam time based samples. The symbols are generated in frequency domain in such as way that they are real in a selected time domain. For the signal to be real in a time domain it is required that the following conditions for the symbol generation process 101 depicted in FIG. 4, as a complex spectrum 102 of complex numbers Gk according to an equation known to those who practice the art. By combining 99 real spectrum 94, even 96 and imaginary spectrum 95 odd 97, the symbol 100 is transformed into time domain by the inverse Discrete Fourier transform (DFT) normalization 98. This is an efficient way of generating a symbol which guarantees that it fits into the designated frequency band by design.

Step (B) Select fittest symbols: Selection is a process in which fitter individuals are chosen to produce offspring for the next generation. The fitter symbols have lower value of the cost function. The modem in one embodiment is loaded with the dictionary of symbols that form the current population. A pseudo-random data stream is then encoded into the symbols sent through the vocoder. On the receiver side the data is extracted by the MLE decoder, and the cost function for each symbol is calculated according to the prescribed equation. The selection pressure is introduced for parents only, i.e., the least fit parents are removed from the population to make room for the next generation of offspring. Ranking selection is used to select pairs of individuals from the mating pool that will produce offspring for the next generation. It assigns probabilities, based on the individual symbol's rank, ignoring absolute fitness value. The individual symbols in the mating pool are sorted according to their fitness and then assigned a count which is mathematically defined. The count is the symbols position in the sorted list. The best individual receives rank one, the second best receives two and so on. The selection probability is then expressed by a specific mathematical equation known in the art where a specific quantum is constant, such that mathematical quantum controls the slope of the parent distribution: the closer constant to one, the more parent is weighted towards the fitter individuals; and parent selection equals N symbols. Then, parents are selected by one “roulette” wheel rotation. For each N off offspring two parents are produced.

Step (C) Produce new symbols and update symbol set: The new symbol generation process consists of two parts: crossover and mutation. Crossover and mutation operate on the frequency domain representation of the symbols in order to ensure that their spectra do not extend beyond the band limits of a selected channel environment. Crossover: The new offspring is produced by a crossover process, in which new individuals are generated by exchanging features of the selected parents. When the parents are represented by vectors of real numbers: that represent real-coded Genetic Algorithms (GA), utilise blend crossover, a mathematical process known to the art. The process is known to provide a satisfactory combination of exploration and exploitation. The next step is to label two parents chosen as Generation One and Generation Two accordingly.

Mutation: the mutation process is to keep diversity of a population and promote searching in the solution space that cannot be represented by the individuals of the current population. According to this process, a single element of the offspring frequency representation, chosen at random, is replaced by a random complex variable. Both genetic operators used in offspring generation have non-unity probabilities of occurrence. The probability of crossover and the probability of mutation are usually chosen empirically. When the crossover is not applied, the first parent, is copied directly into the offspring generation. Then the mutation operator is applied, or not, as usual. Generated offspring “0” is then used to construct the time domain symbols defined using defined equations. After the new offspring have been generated they replace the least parents in the population.

STEP (D) Iterate epochs: The steps B and C are repeated until one of the following conditions is met: a target error rate Ct is achieved or the maximum number of epochs N epoch have passed. The number of epochs has to be chosen large enough to allow the GA convergence. Although replacing a large fraction of the population at each epoch allows rapid evolution, it stipulates large residual error and can cause instability. To address this issue, a variation of the elitism strategy is applied. The number of offspring generated every N off epochs was reduced by one every N reduct epochs, thereby minimizing the residual error and providing “smoother” adaptation. For proper operation this requires the number of epochs N epoch be equal to the initial number of offspring multiplied by N reduct, so at the final stage of operation last N reduct generations, there is one offspring being replaced every generation. If there is no obvious target error rate for the application, or it should simply be as low as possible, then the algorithm is allowed to iterate for the full N epoch. Alternatively, the symbol generation process can be stopped if there has not been any improvement for a certain time period. The new symbol and Step (D) Iterate epochs: repeat steps B and C until sufficiently optimal symbol set is produced, or a maximum number of iterations is exceeded. In Step (A) According to the chosen GA strategy, the entire population S 81 as shown in FIG. 3, constitutes a single symbol set.

Additional objects and advantages of the invention will readily occur to those skilled in the art. The invention in its broader aspects is not limited to specific details, representative devices, and illustrative examples shown and described. Accordingly, departures may be made from such details without departing from the spirit or scope of the general invention's means and methods defined by the appended claims and their equivalents.

What is claimed is:

1. A method for optimizing a communications neural network comprising:
representing the communications neural network with a population of plural individuals, each individual corresponding both to a symbol transmitted in the communication neural network and to a hidden neuron in the communication neural network; and
using a genetic algorithm to process the population through a one or more successive generations, the processing of each generation including
deriving from individuals of the generation a neural network of the generation,
testing the neural network of the generation,
ranking each individual in the generation based on the testing,
removing a first group of individuals from the generation based on the ranking,
deriving from each of one or more selected pairs of individuals in the generation an offspring individual, and
adding the offspring individuals to the population, the adding to result in a successive generation of the population.

2. A method comprising encoding a data communication using symbols derived by the method of claim 1.

3. A method comprising decoding a data communication using neural network characteristics derived from the method of claim 1.

4. The method of claim 3 wherein the data communication is on a band-limited, non-linear channel.

5. The method of claim 3 wherein the data communication is on a voice-only channel of a communication network.

6. The method of claim 5 wherein the communication network is a Global System for Mobile Communications (GSM) network.

7. The method of claim 1 wherein a neural network of a generation is a Radial Basis Function network.

8. The method of claim 1 wherein each individual comprises
a first gene representing an active frequency content of the corresponding symbol,
a second gene representing a center vector of an activation function for the corresponding hidden neuron,
a third gene representing a width of the activation function for the corresponding hidden neuron.

9. The method of claim 1 wherein deriving from each of one or more selected pairs of individuals in the generation an offspring individual includes calculating for each individual a probability of becoming a member of a pair of individuals.

10. The method of claim 1 wherein deriving from each of one or more selected pairs of individuals in the generation an offspring individual includes calculation of one of a group consisting of a mutation probability, a crossover probability and a combination thereof.

11. The method of claim 1 wherein the number of individuals in the first group is reduced between two successive generations.

12. A machine-readable medium having executable instructions which when executed cause a machine to perform a method comprising:
representing the communications neural network with a population of plural individuals, each individual corresponding both to a symbol transmitted in the communication neural network and to a hidden neuron in the communication neural network; and
using a genetic algorithm to process the population through a one or more successive generations, the processing of each generation including
deriving from individuals of the generation a neural network of the generation,
testing the neural network of the generation,
ranking each individual in the generation based on the testing,
removing a first group of individuals from the generation based on the ranking,
deriving from each of one or more selected pairs of individuals in the generation an offspring individual, and
adding the offspring individuals to the population, the adding to result in a successive generation of the population.

13. A method comprising encoding a data communication using symbols derived using the machine-readable medium of claim 12.

14. A method comprising decoding a data communication using neural network characteristics derived using the machine-readable medium of claim 12.

15. The method of claim 14 wherein the data communication is on a band-limited, non-linear channel.

16. The method of claim 14 wherein the data communication is on a voice-only channel of a communication network.

17. The method of claim 16 wherein the communication network is a Global System for Mobile Communications (GSM) network.

18. The machine-readable medium of claim 12 wherein a neural network of a generation is a Radial Basis Function network.

19. The machine-readable medium of claim 12 wherein each individual comprises
a first gene representing an active frequency content of the corresponding symbol,
a second gene representing a center vector of an activation function for the corresponding hidden neuron,
a third gene representing a width of the activation function for the corresponding hidden neuron.

20. The machine-readable medium of claim 12 wherein deriving from each of one or more selected pairs of individuals in the generation an offspring individual includes calculating for each individual a probability of becoming a member of a pair of individuals.

21. The machine-readable medium of claim 12 wherein deriving from each of one or more selected pairs of individuals in the generation an offspring individual includes calculation of one of a group consisting of a mutation probability, a crossover probability and a combination thereof.

22. The machine-readable medium of claim 12 wherein the number of individuals in the first group is reduced between two successive generations.

23. An apparatus, comprising:
a modeling component to represent the communications neural network with a population of plural individuals, each individual corresponding both to a symbol transmitted in the communication neural network and to a hidden neuron in the communication neural network; and
a testing component to process the population through a one or more successive generations using a genetic algorithm, the processing of each generation including
deriving from individuals of the generation a neural network of the generation,
testing the neural network of the generation,
ranking each individual in the generation based on the testing,
removing a first group of individuals from the generation based on the ranking,
deriving from each of one or more selected pairs of individuals in the generation an offspring individual, and
adding the offspring individuals to the population, the adding to result in a successive generation of the population.

24. A method comprising encoding a data communication using symbols derived using the apparatus of claim 23.

25. A method comprising decoding a data communication using neural network characteristics derived using the apparatus of claim 23.

26. The method of claim 25 wherein the data communication is on a band-limited, non-linear channel.

27. The method of claim 25 wherein the data communication is on a voice-only channel of a communication network.

28. The method of claim 27 wherein the communication network is a Global System for Mobile Communications (GSM) network.

29. The apparatus of claim 23 wherein a neural network of a generation is a Radial Basis Function network.

30. The apparatus of claim 23 wherein each individual comprises
a first gene representing an active frequency content of the corresponding symbol,
a second gene representing a center vector of an activation function for the corresponding hidden neuron,
a third gene representing a width of the activation function for the corresponding hidden neuron.

31. The apparatus of claim 23 wherein deriving from each of one or more selected pairs of individuals in the generation an offspring individual includes calculating for each individual a probability of becoming a member of a pair of individuals.

32. The apparatus of claim 23 wherein deriving from each of one or more selected pairs of individuals in the generation an offspring individual includes calculation of one of a group consisting of a mutation probability, a crossover probability and a combination thereof.

33. The apparatus of claim 23 wherein the number of individuals in the first group is reduced between two successive generations.
